(19) United States
(12) Patent Application Publication
(10) Pub. No.: US 2023/0289527 A1
(43) Pub. Date: Sep. 14, 2023

(54) CONVERGENCE OF DOCUMENT STATE AND APPLICATION STATE

(71) Applicant: Simon Booth, Washington, DC (US)

(72) Inventor: Simon Booth, Washington, DC (US)

(21) Appl. No.: 17/653,921

(22) Filed: Mar. 8, 2022

(51) Int. Cl. G06F 40/289; G06F 40/221; G06F 40/284; G06F 40/166; G06F 16/84

(52) U.S. Cl. CPC G06F 40/289; G06F 40/221; G06F 40/284; G06F 40/166; G06F 16/84

(57) ABSTRACT

Disclosed are systems, apparatuses, processes, and computer-readable media to converging state between generated and revised documents. A method includes executing a first instance of a user interface for creating a plurality of paragraphs from a set of claims; in response to the execution of the first instance of the user interface, creating the plurality of paragraphs based on input into the user interface; inserting the plurality of paragraphs into a document associated with the document processing application; after a claim in the set of claims is edited in the document, executing a second instance of the user interface; and in response to the execution of the second instance of the user interface, revising the plurality of paragraphs based on input into the user interface during the second instance. The paragraphs can be revised based on disclosed mechanisms to embed metadata within the XML content.

### TECHNICAL FIELD

The present technology pertains to a method and apparatus for generating documents using natural language processing and embedding metadata in the document to identify modifications made to the document from a document processing application.

### BACKGROUND

Formal documents that are authored for administrative agencies are required to have a specific structure to comport with requirements of the administrative agency. The requirements include procedural-based requirements (e.g., margins, font size, etc.) and statutory-based requirements (content).

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIGS. 1 and 2 illustrate systems for generating a patent specification;

FIG. 3 illustrates an example patent-specific application capable to creating documents or drawings from other material in accordance with some examples;

FIG. 4 illustrates an example illustration of a user interface for arranging claim segments and includes a claim panel 402 that displays claim segments embedded within the claims based on a feedback scheme in accordance with some examples;

FIGS. 5A and 5B illustrate an example of a patent-specific application and using a custom tag to promulgate a change in a claim into the specification in accordance with some examples;

FIGS. 6A and 6B visually illustrate graph objects that can be created by a patent-specific application to identify changes to the document state to update the application state of the patent-specific application in accordance with some examples;

FIG. 7 illustrates another patent-specific application configured to convert claim content into specification content in accordance with some examples;

FIG. 8 illustrates an example method for creating a document using a patent-specific application in accordance with some examples;

FIG. 9 illustrates a method for updating a document that was created by an automation application and revised in a document processing application in accordance with some examples;

FIG. 10 illustrates an example method 1000 of using custom tags and a user interface based on modification to a document in accordance with some examples;

FIG. 11 illustrates a method 1100 for updating an application state based on custom tags embedded in the document in accordance with some examples;

FIG. 12 illustrates another method 1200 for updating a document that was created by an automation application and revised in a document processing application in accordance with some examples; and

FIG. 13 illustrates an example of a computing system in accordance with some examples.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

As machine learning, especially natural language processing (NLP), become more robust it is tempting to look to these tools to perform certain tasks that are considered formulaic. While these tools are indeed beneficial, they are not suitable for producing completed work product in most instances. Machine learning tools are not yet able to take raw inputs, understand them, and write an explanatory document about those raw inputs. Therefore previous attempts at document creation using machine learning tools have focused on using structured inputs.

In the example tools used for drafting patent applications, a common structured input begins with the claims. Indeed those skilled in the art of drafting patent applications often begin with claims because they are the most important part of the document, and are designed to recite the novel aspects of an invention. However, such tools are limited to restructuring clauses of claims into sentences and pasting them into a document, which is insufficient to produce any useful work product. Further, existing tools only use method claims as inputs because method claims are predictable and structure can be inferred based on a gerund verb phrase (e.g., “transmitting a message”) and identifying non-gerund phrases based on inferences and lack of gerund verbs. Other types of claims, such as apparatus or system claims, have a larger amount of variety and cannot be handled based on inferences.

New tools are being developed to improve patent drafting experience from a document processing application. Tools can be standalone applications that receive claims and drawings as input and create a corresponding specification. In some cases, the applications can be integrated directly into the document processing application using a variety of techniques such as sideloading, etc. These tools vary significantly in their capability and automate low-value processes such as converting a method claim into an apparatus claim, etc.

However, once a document is generally finished in existing tools, the application state of the patent tools becomes separate from the document state. For example, an application can create a flowchart and description of that flowchart, but later modifications to the flowchart cannot be promulgated because the document state and the application state become separate and distinct. The document cannot easily be brought back into the patent application because of complexities such as track changes, comments, etc. This can even be an issue when a web-based add-in application that executes within the context of the document processing application and information within the add-in application and the document processing application diverges. Many different types of solutions have been attempted, such as removing the document from the document processing application itself into a patent-specific application, inserting metadata into the application, but no solution exists. For example, paragraph numbers in an OpenXML document are implicit and are automatically numbered, and non-compliant markup cannot be inserted because validation of the OpenXML removes non-compliant markup. While metadata can be persisted in the XML parts of the document (e.g., a separate XML content that is separate from the OpenXML that includes the body of the document), that metadata cannot be directly mapped to the content.

The present technology improves over existing solutions by providing an OpenXML solution to embed metadata track document state and map document state back into the application state. As used here, application state refers to the state of an executable application for a particular function such as patent application drafting. In some cases, a paragraph identifier using a custom OpenXML tag can be used to identify each paragraph and identify events such as moving the paragraph within the document, addition of new paragraphs, or deletions of paragraphs. Other illustrative aspects include marking particular blocks of description with a custom OpenXML tag, and the custom OpenXML tag includes expected text that is within the OpenXML tag. In this manner, the patent-specific application can identify changes to content created by that patent-specific application or identify changes to other content that should be promulgated into the custom OpenXML tag.

The present technology can link application state into the document itself so that modifications to the document can be easily promulgated to keep the application consistent. Based on the disclosed technology, the changes to the document can be reflected back into the patent-specific application, and changes in the patent-specific application can be promulgated into the document. This simplifies many different tasks that can be burdensome when an aspect of the patent changes later.

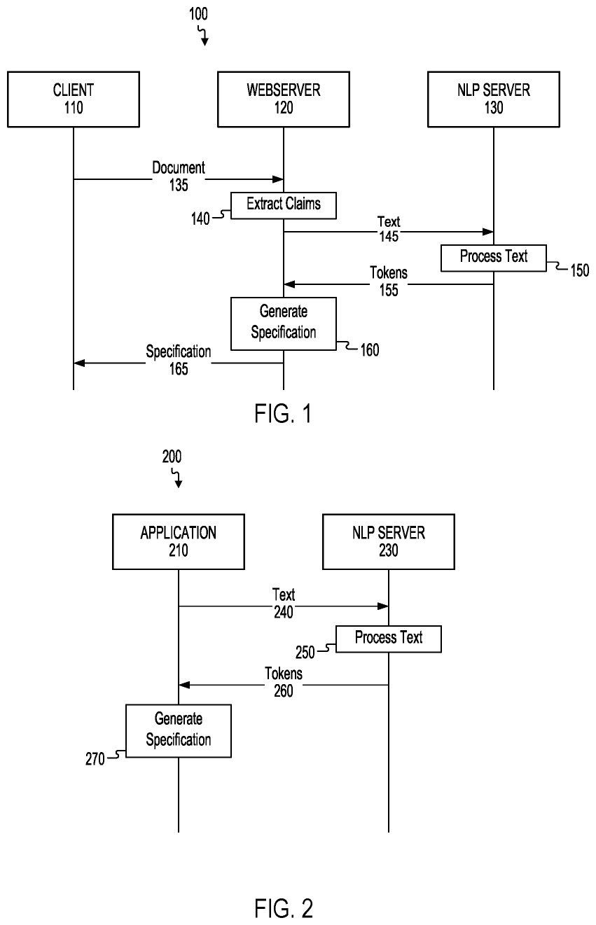

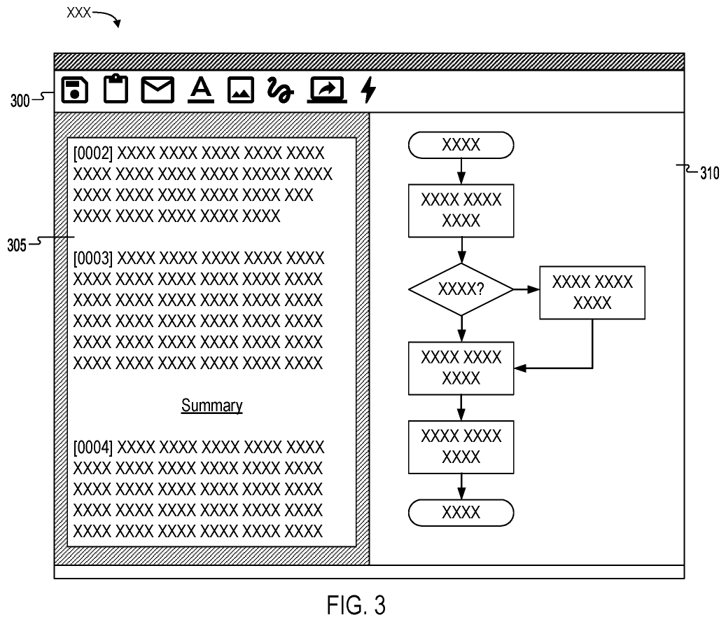

FIGS. 1 and 2 illustrate systems for generating patent applications. In particular, FIG. 1 illustrates a server-based process to generate the formal document, and FIG. 2 illustrates an application-based generation process to generate the patent specification. In general, each of these systems generally receives method claims as input and (1) converts the method claims into apparatus or device claims, (2) generates a description of a flowchart-based on a set of method claims (i.e., a single independent claim and generally at least one dependent claim that depends from that single independent claim), and (3) creates a single generic flowchart diagram based on the independent claim. The systems may also be able to insert generic device descriptions and boilerplate based on a client's requirements.

Referring to FIG. 1, a system 100 comprises a client 110 that connects to a webserver 120 for generating the patent specification. In the system 100, the client 110 transmits a document at step 135 that includes a set of method claims to the webserver 120. Having received the document with method claims, the webserver 120 extracts the method claims from the document at step 140. After extracting the claim, the webserver 120 transmits text that corresponds to the method claims to a natural language processing (NLP) server at step 145

The NLP server 130 receives the text and processes the text into NLP tokens at step 150. An NLP token (or token) is generally a single word or a single character (e.g., punctuation) and is assigned several properties. For instance, each NLP token is generally assigned an identifier (ID), a part of speech tag that identifies the part of speech (e.g., noun, verb, etc.), and a dependency label that identifies how the part of speech depends on other tokens, and so forth. In general, NLP engines also assign what is referred to as a fine part of speech, which further clarifies the purpose of that word. For example, a noun can be the object of the sentence, but could also be part of a compound noun (that is, a single object that has a name including several words), which is also referred to as an n-gram.

A dependency label identifies how the token depends on other tokens. For example, an NLP token may be a determiner (i.e., an article such as “the” or “an”), a nominal subject, a clausal subject, an adverbial clause, conjunction, punctuation, and so forth. A dependency label referred to as root corresponds to the root of the sentence or phrase and is not dependent on any other tokens in that sentence. For example, in the sentence “I love fries,” the NLP token “love” is the root, “I” is the proper noun having a dependency of noun subject from the root, and “fries” is the noun that is a direct object of the root. For example, the output of this sentence is illustrated in Table 1 below.

TABLE 1

| | | | Course | | Dependency |
|---|---|---|---|---|---|
| Id | RootId | Text | Tag | Fine Tag | Label |
| 0 | 1 | I | Noun | Personal Pronoun | Nominal Subject |
| 1 | 1 | love | Verb | Non-3^{rd} person | Root |
| | | | | present verb | |
| 2 | 1 | fries | Noun | Plural Noun | Direct Object |

The NLP server 130 transmits the tokens to the webserver 120 at step 155, which converts the tokens into a patent specification at step 160. The webserver 120 creates a flowchart and a corresponding description to that flowchart based on NLP tokens from the method claims. To create the description of the flowchart, the webserver 120 extracts the individual portions of tokens that can be converted into a single sentence based on the order in which they are identified in the method claim (i.e., text).

Specifically, the webserver 120 converts an active step, which is a clause having an active gerund as its root word, into a sentence using a different tense. For example, the webserver 120 may convert a phrase “performing a function” into “perform a function” and then add generic content such as “a processor may” to the beginning of the phrase, thus forming “a processor may perform a function.” In this case, the generic structure is predetermined and not associated with user input. That is, the webserver 120 receives the method claims in a particular sequence and then generates a flowchart description based on the order of claims. After generating the specification, the webserver 120 transmits the patent specification with the flowchart description and additional boilerplate back to the client 110 at step 165. The webserver 120 may also transmit any created flowchart drawings or generic drawings at step 165.

FIG. 2 illustrates a system 200 that is similar to the system 100, but has a different architecture. In particular, the system 200 comprises an application 210, which may be executing on a client computer, which communicates with the NLP server 230.

The application 210 extracts the text of the method claims and transmits the text to the NLP server 230 at step 240. The NLP server 230 processes the text into NLP tokens at step 250 and returns the text as NLP tokens at step 260 to the application 210. In response to receiving the NLP tokens, the application 210 may generate the specification or part of the specification at step 270. The application 210 generates a flowchart based on the independent claim, generates a flowchart description based on the order of the claims, and composes apparatus or device claims from the method claims.

As noted above, the system 100 or system 200 may also compose additional claims from the method claims. In more detail, the system 100 or system 200 converts a method claim, which has gerund verbs, into a device or system claim, which has present tense verbs. However, in each case, the system 100 or system 200 will only provide generic structure (e.g., a processor, a memory, a display). The system 100 or system 200 may also generate “means” claims by changing the preamble and adding “means for” before the root gerund verb.

Patent application drafting tools focus on method claims because of the predictability of the method claims. In some aspects, the disclosed systems have improved NLP analysis method to extract phrases of a claim irrespective of the statutory type (e.g., method, apparatus, etc.). In the case of improved NLP analysis, an application, either a web-based application (e.g., React, Angular, etc.) that executes in a browser sandbox or a native application (e.g., an Electron application, a React Native Desktop application, etc.) may be configured to use the improved NLP to sequence together a patent application. The application or system (e.g., a browser connected to a web server) can be configured to extract text from the claim and identify the language tokens. For example, an NLP server generates token identification information to indicate a position of the token in the input text and to identify token relationships based on the various token properties (e.g., dependency label, part of speech, etc.). The system can extract phrases and subjects of the phrases from the tokens. In some instances, the phrases do not have a subject (e.g., the phrase is a gerund verb in a method claim and the subject is the preamble of the claim) or a subject for the sentence can be provided based on a context of the phrase. The phrases may be extracted based on the identification of grammar features that link complete phrases such as adpositional phrases (e.g., “after receiving the message”, etc.) and conjunctions (e.g., “receiving, processing, and storing”) that can be used to form a complete sentence. For example, an adpositional phrase cannot be used to create a sentence because it provides context to another phrase.

The application can be provided with the processed language in a format that identifies various contextual information to allow an application to configure the different phrases into text. An example data structure of a single paragraph in extensible markup language (XML) format is illustrated in Table 2 that can configure the various sentences using different types of spans that identify the different phrases of the paragraph.

```
TABLE 2
<p>
  <descriptiveSpan subject=“filter circuit” context =“feedback circuit”
      sentencePreamble=“The feedback circuit ”>
    a filter circuit on a path that connects the output terminal of the
    replica transistor to a base or a gate of the bias transistor via the
    current mirror circuit and the control path
  </descriptiveSpan>
  <span>, </span>
  <functionalSpan subject=“filter circuit” context =“feedback circuit”
      asPresent=“the filter circuit attenuates a frequency component of
      a fundamental wave of the input signal and a frequency component
      of a modulated wave of the input signal” asPast=“the first circuit
      attenuated a frequency component of a fundamental wave of the
      input signal and a frequency component of a modulated wave of
      the input signal”>
    the filter circuit being configured to attenuate a frequency component
    of a fundamental wave of the input signal and a frequency component
    of a modulated wave of the input signal
  </functionalSpan>
  <span>, and wherein </span>
  <descriptiveSpan subject=“filter circuit” context =“feedback circuit”
      sentencePreamble=“In some examples, ”>
    the base voltage or the gate voltage of the bias transistor is
    controlled in accordance with a current flowing in the control path
  </descriptiveSpan>
  <span>.</span>
</p>
```

In some aspects, the application may be configured to create drawings or a specification based on the provided XML data, or any other suitable format such as Javascript object notation (JSON). For example, in one illustrative example application, the claims can be used to generate a flowchart in a user interface, which may be referred to as a flowchart user interface, and native drawing files (e.g., Microsoft Visio) and document files (e.g., Microsoft Word) can be generated from the application.

However, these documents suffer from having a separate state in the application and a state in the document. Once the document is rendered, there is no mechanism to allow changes in the document to be incorporated into the application. A pure differential approach (e.g., a text diff) does not work because it can only identify simple changes that occur within a known line and complex changes, such as inserting paragraphs, can create significant difficulty in mapping changes to the text, which may not be perfectly identical because NLP can be used to change the claim (e.g., changing ‘processing a message’ to ‘a device configured to process a message’). For example, if a claim in a patent application is changed, and a portion of that claim is used to derive another sentence (e.g., the derived sentence is not identical to the claim), the diff will not be able to map changes from the claims back into every instance that portion of the claim is used to derive content the document.

In some cases, an OpenXML document is accessed via an API to simplify various aspects of the document. The OpenXML specification itself is long and complicated, in excess of 5000 pages for a single part, and applications use a third-party library to create and modify OpenXML libraries. Despite the complexity of OpenXML, OpenXML libraries cannot support every feature. For example, simple OpenXML libraries may focus on a specific type of document such as a presentation or a spreadsheet and exclude various complicated functions such as Mathematical objects.

In some cases, an add-in application may be able to directly access the OpenXML content itself because the add-in exposes built-in functions of the application (e.g., search) based on a presentation of the content. For example, in a word processing document, the content presented by the add-in functions is based on the view of the document and would, as an example, include deleted content if track changes were illustrated. To address this issue, a custom library for parsing the XML can strip out content irrespective of the view. For example, a common function is the identification of parts (or elements) having a reference identifier. A tracked change to that modification created false positives because the final text (not the visible text in the document processing application) corresponded to the correct text. While this custom library was being designed, various experiments were conducted to attempt to inject metadata into some of the OpenXML that would be OpenXML-compliant, but is injected by the application and cannot be linked to application state. For example, a paragraph (<w:p>) may have an explicit identifier in the file, but that identifier was not available to any other application except the document processing application. Further, the explicit identifier could not be mapped to state, rendering it useless.

A solution was identified that uses a standard-compliant tag that is unavailable in third-party libraries. There are two different custom tags, a custom XML tag (<w:customXml>, and a smart tag (<w:SmartTag>). The custom XML tag is a schema-based tag and the smart tag is a schema-free tag. With the custom tags, and with the custom XML library, the custom tags can be inserted into the OpenXML with metadata that links application state to the document. In some aspects, the custom XML tags may not be visible within the document processing application and can be used to embed immutable data that is not perceivable to the user. Immutable data refers to content that cannot be modified within an external application (e.g., a word processor), but can be removed or destroyed by, for example, deleting a paragraph of content. The custom XML tags can be used to embed various types of data that would link the document state to the application state and when the application is executed, the application can identify changes to the document and map those changes back into the application state. For example, a portion of a sentence that corresponds to a phrase in the claim may change. When the patent-specific application loads the revised claim from the document, the patent-specific application can identify portions of the specification (e.g., summary, abstract, description) that use that claim language and the patent-specific application can update that language automatically. In some cases, the patent-specific application may be configured to use the NLP to build the correct phrase and insert the correct phrase into the various custom tags.

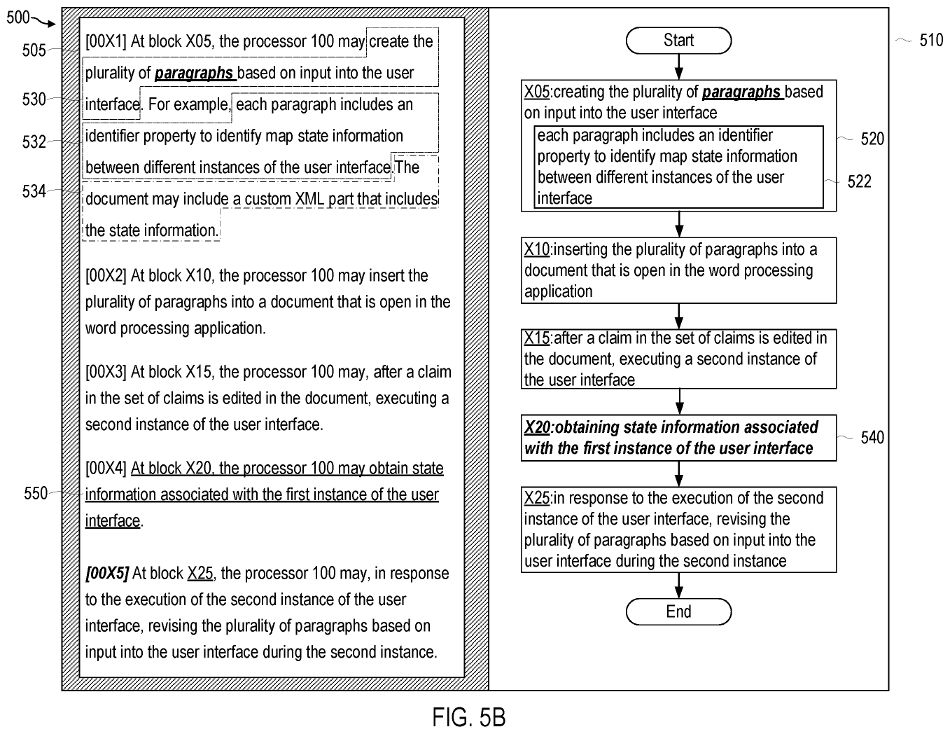

Table 3 below illustrates an example paragraph with custom tags and illustrates various types of information that can be embedded into a single paragraph. For purpose of simplicity, the example paragraph omits some tags (e.g., the text <w:t> tag) and attributes in an OpenXML document for clarity. In Table 3, the paragraph can include metadata that identifies a paragraph number of the paragraph and a unique identifier, a linked previous neighbor paragraphs, a related figure (e.g., FIG. 5), a claim source (claim 1), and so forth. Further, the paragraph can include runs (<w:r>, which can also be referred to as spans) of text and the runs can identify a phrase of that paragraph. When the patent-specific application views the paragraph in Table 3, the patent-specific application can determine that the child content (e.g., within the tags) and the attribute that the patent-specific application embeds in the custom tag are different. In this aspect, the patent-specific application can therefore determine that the text was edited, and the related paragraphs that are identified in the custom tag's attributes should be updated.

```
TABLE 3
<w:p>
  <w:smartXml>
    <w:smartXmlPr>
      <w:attr w:paragraphId w:val=″100″/>
      <w:attr w:Id w:val=″AJi1a-1mUf1″/>
      <w:attr w:nextParagraphId w:val=″lkk1j-00091″/>
      <w:attr w:prevParagraphIUd w:val=″m5YH1-POnb1″/>
      <w:attr w:relatedFigureId w:val=″5″/>
      <w:attr w:claimId w:val=″1″/>
    </w:smartXmlPr>
  <w:smartXml>
  <w:r>In one example, the computing device may </w:r>
  <w:smartXml phrase=”receive a network route from the PCE” claimSource=”1”,
    phraseId=”kd81d-24akO” relatedParagraph=”XXXXX-XXXXX”
    relatedParagraph=”XXXXX-XXXXX” relatedParagraph=”XXXXX-XXXXX”
    relatedParagraph=”XXXXX-XXXXX”>
    <w:r>receive a network route from a network controller</w:r>
  </w:smartXml>
  <w:r>. For example, the SDN controller can be configured to provide this
    message. </w:r>
</w:p>
```

In this example, the first custom tag includes a property tag (<w:smartXmlPr>) with attributes, and the second custom tag includes attributes within the tag itself. In some aspects, an attribute of the first tag may be different and more complicated such as Javascript object notation (JSON) that describes a complex object and the JSON object can be encoded via a base64 value into a single attribute. This may simplify serialization and deserialization based on the type of application. The first custom tag includes a phrase that identifies the original text of the phrase, and if the run content (e.g., <w:r> changes, the custom tag can flag an issue. In some cases, this can be used to promulgate a later change in a claim to fix a typographical error for example, as further illustrated in FIGS. 5A and 5B. The custom tag can also include a phrase identifier that maps to the original phrase in the claim, and can include other information such as related paragraphs that include the content. Non-limiting examples of usage of the phrase in a patent application include, for example, a description of a flowchart, a description in a block diagram, a summary of the application, an abstract, a claim (e.g., as part of an apparatus claim), or a multiple-dependency style of claims for literal support in some jurisdictions.

The custom tag illustrated in Table 3 can also identify various information to identify changes. For example, the first custom tag includes a paragraph number (100) that identifies it's ordered and labeled paragraph number within the document. If another paragraph was inserted before the paragraph, when the document is returned to the patent-specific application, the patent-specific application can identify that the paragraph sequence is incorrect based on the paragraph number and other information, such as a next paragraph identifier and a previous paragraph identifier, and use this information to identify changes within the document. In other cases, the paragraph can be explicitly linked to figures, descriptions, reference labels (e.g., reference numerals). For example, a patent-specific application can be configured to extract content from other applications and the custom tags can be used to identify relevant content from that document and then remove all relevant content and assemble the content into a different patent application.

The patent-specific application itself can update the content based on a user interface presented to the user. Based on the custom tags, the application state can be directly embedded into the document itself. When the document is returned to the patent-specific application, the patent-specific application can identify changes to the document and those changes are promulgated into the application state. For example, the patent-specific application can identify that a claim may have been modified by a client and, when that document is loaded into the patent-specific application, the patent-specific application can identify content within the specification that is linked to that claim, and promulgate those changes into the specification.

In some cases, while the custom tag cannot be mutated in an external application, the custom tag can be destroyed based on deleting the entire content. For example, a recitation of a claim can be removed and the patent-specific application can provide a status of the various linked portion of the specification. For example, a description in a flowchart related to the claim limitation that was removed can be denoted to indicate that its corresponding claimed subject matter is no longer present. This could prompt the user of the patent-specific application to, for example, update the description based on a change that was made during review.

In some cases, the patent-specific application can also insert global information into the document itself. For example, an openXML document accepts a custom XML part that can be used to link content controls another other material (e.g., a mail merge, etc.) of the document. For example, the patent-specific application can include a custom XML part that may be loaded with relevant static data such as the claims, paragraph information, etc. When the document is returned to the patent-specific application, the patent-specific application can perform several analyses to identify relevant changes such as deleted paragraphs, revised claims, etc. The custom XML part applies to a global state of the document and the custom tags applies to instances or the rendered content. That is, the custom tags apply to content inline and identify, for example, how a specific portion of text corresponds to a portion of a claim.

A custom XML part can only identify content from a global perspective based on where the content is expected and, for example, could not identify whether text that is modified was based on that claim. The custom XML part can be used for other global concepts, such as ensuring that the document loaded into the patent-specific application is the most recent version of that document. For example, the patent-specific application can inject a modification timestamp into the custom XML part, and store that same timestamp on a server. When the patent-specific application loads the application, the patent-specific application can compare the timestamps to ensure that the document version being loaded corresponds to the expected timestamp of the server.

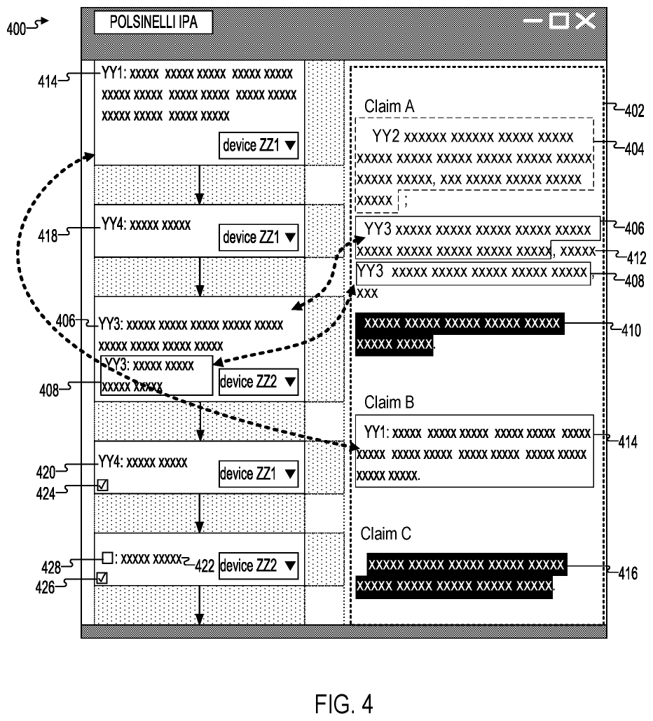

In some cases, restoring the document state with the patent-specific application can also allow the patent-specific application to provide additional changes based on content tagged within the document. This allows the modifications to be applied consistently. For example, modifying a claim within the document can be linked to various document editing functions such as a flowchart user interface, which is described in further details with reference to FIGS. 3, 4, 5A, and 5B. By modifying the claim within the patent-specific application, the patent-specific application can promulgate necessary changes into the document to correct any errors, revise language for consistency, and so forth. This provides improved work product that is consistent and easier to review while reducing repetitive tasks associated with editing and revising a patent application.

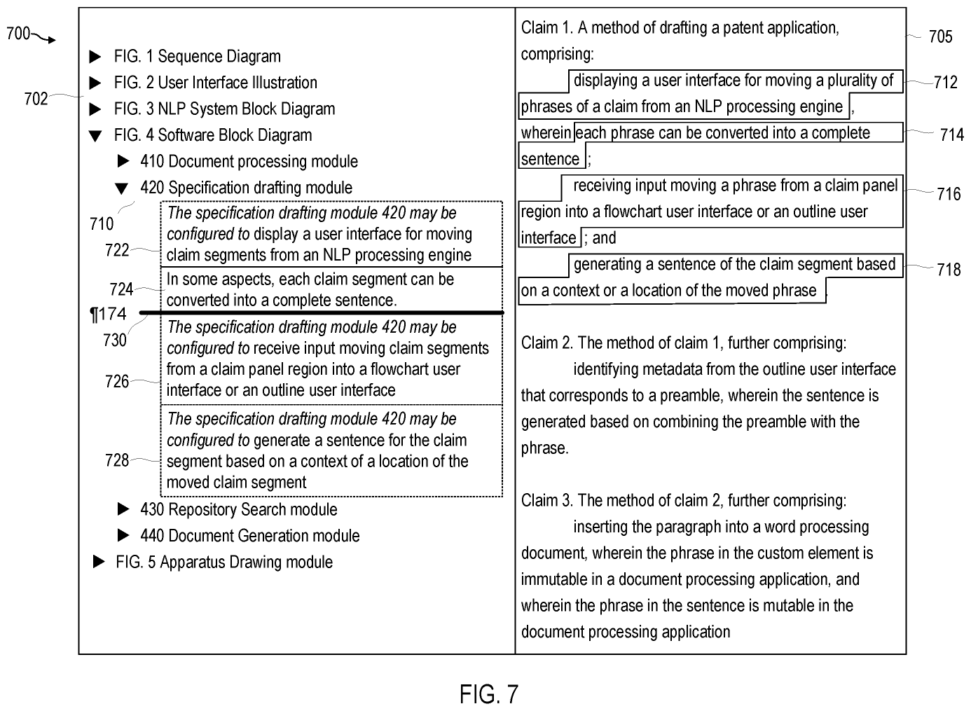

The custom tags can be used to build complex data structures, such as a graph, that can identify changes to make throughout the document, identify content to extract, or promulgate changes from the patent-specific application into the document. An example graph is illustrated with reference to FIG. 7.

FIG. 3 illustrates an example patent-specific application 300 capable of creating documents or drawings from other material in accordance with some examples. In some cases, the patent-specific application 300 is a stand-alone application designed in a framework to be executed using natively compiled code (e.g., WinForms, WPF, React Native Window, etc.) or code that is interpreted (e.g., Electron, etc.). In other cases, the patent-specific application 300 can be a web-based application that executes in a browser sandbox using various frameworks (e.g., Angular, React, Blazor, Vue, etc.). In some cases, the web-based application can be compiled into Webassembly bytecode using, for example, Rust and its various tools to build compliant Webassembly bytecode and provide near-native execution speeds in a web browser sandbox. In other aspects, the patent-specific application 300 can be executed within another application such as being directly embedded into a word processor (e.g., Microsoft Word with the VSTO model) or can be injected as a web application that executes the patent-specific application 300. In some cases, the patent-specific application 300 can be injected into another web application (e.g., Google Docs, etc.).

The patent-specific application 300 is illustrated to include a document region 305 for viewing or editing text associated with a patent application. The patent-specific application 300 can also include a diagram region 310 for displaying drawings for the application. In some cases, the diagram region 310 can be configured to modify drawing content. For example, the diagram region 310 can include a diagramming function inserted from an external library. In some aspects, the diagram region 310 can be a flowchart user interface that uses web-based technology (e.g., scalable vector graphics (SVG), or other document object model content) for enable interaction and linking with the patent-specific application 300. In some case, the diagram region 310 can be a viewer that displays, for example, SVG content that was derived from another type of diagram, such as a Microsoft Visio file (.vsdx) or a CAD file (.dxf). The patent-specific application 300 can be configured to link information within the diagram, such as text, into the document region to provide various benefits such as typeahead, identification of reference labels to automate typing of long terms, etc.

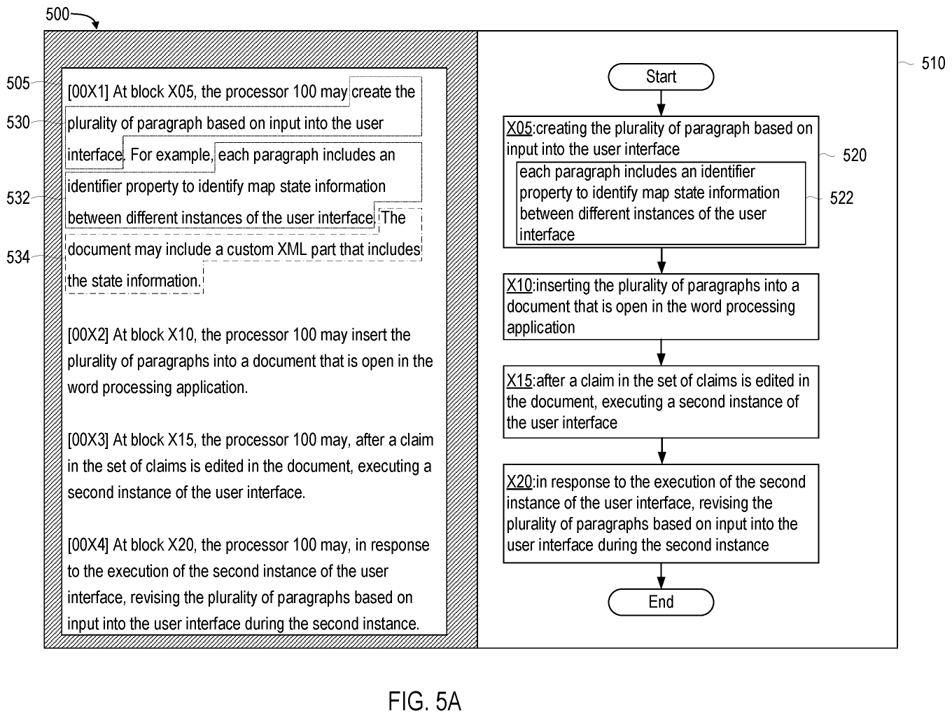

FIG. 4 illustrates an example illustration of a user interface 400 for arranging claim segments and includes a claim panel 402 that displays claim segments embedded within the claims based on a feedback scheme in accordance with some examples.

In particular, FIG. 4 illustrates three claims (A, B, and C). Claim A includes claim segment 404, claim segment 406, claim segment 408, and claim segment 410. In addition, claim A incudes a common word 412 that is not allocated to any claim segments and any trailing or leading punctuation or whitespace is excluded from the claim segments. Claim B includes claim segment 414 and claim C includes claim segment 416.

The user interface 400 allows the user to drag a claim segment from the claim panel 402 and drop a claim segment. When a claim segment is placed into the flowchart, visual feedback is provided in the claim panel 402 to visually illustrate that the claim segment is allocated within the flowchart. For example, claim segment 414 was previously dragged to precede claim segment 406 in the flowchart user interface. Although not illustrated, claim segment 404 is not displayed because it precedes claim segment 414 within user interface 400 and can be viewed by scrolling. For clarity, the dashed lines illustrated in FIG. 4 illustrate claim segment 406, claim segment 408, and claim segment 414 and their respective positions in the user interface 400 and the claim panel 402. The claim segment 406, claim segment 408, and claim segment 414 may also include a label (e.g., a reference numeral) that is used to label each active claim segment in the user interface 400 and the claim panel 402. In this illustrated example, the claim segment 406 is labeled with YY3 and claim segment 414 is labeled with YY1 to expressly identify their location to facilitate identification of the claim segments.

Claim segment 418, which precedes claim segment 414 in the user interface 400, is not illustrated in the claim panel 402 and may either be provided from another claim that is not illustrated in claim panel 402 or may be separately input using, for example, a supplemental segment component for allowing the user to manually create claim segments. Similarly, claim segment 420 and claim segment 422 are not illustrated in the claim panel 402 and may be associated with claims not illustrated in claim panel 402 (i.e., the claims can be viewed if the claim panel 402 is scrolled downward) or may be separately input and are not found within the claims.

Further, the claim segments illustrated in the claim panel 402 may be color coded to provide a visual feedback. In the example illustrated in FIG. 4, when a claim segment is allocated (i.e., assigned a position) within the user interface 400, the claim segment may be coded with a first color. In particular, claim segment 404, claim segment 406, claim segment 408, and claim segment 414 are allocated within the user interface 400 (with claim segment 404 not being viewable based on scrolling the user interface 400). As noted throughout this disclosure, the various claim segments can be added, moved, and removed from the flowchart. When a corresponding claim segment is deleted from the flowchart (using the delete icon), the claim segment is referred to as unallocated.

Claim segment 410 and claim segment 416, which are displayed in the claim panel 402, are not allocated and are color-coded to provide additional feedback. In particular, claim segment 410 is coded with a second color to indicate that claim segment 410 is an active phrase and is not allocated within the user interface 400. Claim segment 416 is coded with a third color to indicate that claim segment 416 is a passive phrase and is also not within the user interface 400. Claim segment 410 and claim segment 416 also do not include a reference label because they are not allocated within the user interface 400.

Although not illustrated in FIG. 4, the claim segments (or nodes that provide visual containers for the claim segments) may include a delete icon that allows the claim segment to be unallocated from the user interface 400. In response to input to delete a claim segment, the user interface 400 would recalculate the flowchart illustrated in the user interface 400 and change the feedback provided by the corresponding claim segment in the claim panel 402.

In addition, the nodes may each contain a grouping option that allows nodes to be combined into groups or combined with a previous paragraph when the specification is drafted. In this example, a grouping option 424 for claim segment 420 and a grouping option 426 are illustrated and remaining nodes are not illustrated with this option for convenience. When the grouping options 424 and 426 are selected, the specification generation groups these claim segments and drafts the specification based on the grouping. That is, the claim segments 420 and 422 may be described in a single paragraph for simplicity.

Further, the claim segments in the user interface 400 may be configured to be excluded from the final set of claims. In an example, the reference label in the claim segment 422 may be selected to indicate that this subject matter can be excluded from the final claims. In this example, when the reference label is selected, the reference label is replaced by an option 428 that is unchecked to indicate that the claim associated with the claim segment 422 is to be omitted from the final claims. When the option 428 is further selected, the claim corresponding to the claim segment 422 would be included. The option 428 may also be used to suppress a node from being created in a corresponding a flowchart drawing (i.e., a drawing document including the flowchart).

Thus, the claim panel 402 provides a visual feedback scheme that is used in conjunction with the user interface 400 to allow the user to easily manipulate the various claim segments to visually draft the specification using a drag and drop user interface. In addition, additional user interface options are illustrated that further allow finer control of the specification and allowing the user to include content generated from the input claims while simultaneously excluding these claims from the finalized claims. As a result, the user can provide a detailed set of preliminary claims to effectively draft all necessary details, then selectively remove claims from the claims section in the generated patent specification.

In another example, a separate component can be provided to allow claims to be composed into different statutory classes using the claim segments and various templates. In such a component, the user would be able to select a final set of claims based on the set of preliminary claims and the composed claims. The application could manage the claim content using the user interface to ensure correct claim numbering, correct claim dependency, and so forth.

FIGS. 5A and 5B illustrate an example of a patent-specific application and using a custom tag to promulgate a change in a claim into the specification in accordance with some examples.

In particular, FIGS. 5A and 5B illustrate a portion of a view of a patent-specific application 500 that includes a document region 505 and a user interface region 510. The user interface region 510, as described above in connection with FIG. 4, includes a flowchart UI that can allow manipulation of a flowchart to change a description (e.g., the document region 505).

In the illustrated example of FIG. 5A, a first node 520 of the flowchart corresponds to a portion of a claim and includes a child segment 522 that further describes the first node 520. The first node 520 and the child segment 522 translate into a paragraph (e.g., paragraph [00X1]) in the document region 505. However, the claims may change during the preparation of the application due to, for example, preferences associated with an in-house counsel, a minor error, or a change in the claims that can cause downstream effects (e.g., changing a claim term, etc.). FIG. 5A illustrates a grammatical error (e.g., plurality of paragraph) that can be promulgated into multiple sections of the specification.

In a patent-specific application, which that does not utilize the custom XLM tags described herein, that includes a claim to description conversion technologies, a change to the claims cannot be promulgated into text descriptions after the text has been generated because it is rendered and there is no ability to link the rendered text back to the claims. However, the custom tags described herein can be used to enclose the text content within a custom tag to link claim content to the rendered specification. Revising descriptions generated from a claim in a document is a time-consuming process because conversion (or composition) can be used to generate content in multiple places. Moreover, there can be many changes, and promulgating these changes can incur significant effort to maintain consistency. For example, in one exemplary patent-specific application 500, a claim term may appear in the summary, within at least one figure, and within a section for providing literal support for the claims that use a multiple dependency style for other jurisdictions. If the document includes 20 claims and there is an average of one change per claim and method claims are used to generate an apparatus claim and a system claim, there could be at least 120 changes.

For example, the flowchart user interface in the user interface region 510 may be used to generate sentences and paragraphs as illustrated in the document region 505. For example, the first paragraph in the document region 505 may include a sentence portion 532 that is generated from the first node 520 using NLP. For example, the first node 520 comprises a phrase with a gerund verb format and is converted into a present tense and configured with a subject that can be determined by a user (e.g., as illustrated in FIG. 4). The child segment 522 can also be included in the first paragraph as a second sentence portion 532, and the first paragraph may also include a custom sentence 534 that is generated by a user. The document region 505 illustrates that the sentence portions 530 and 532 can be tracked and descriptions around the sentence portions 530 and 532 can be edited, thereby allowing a user to improve the writing by adding transitions, and further qualifying information.

In the illustrated example of FIG. 5B, the flowchart user interface in the user interface region 510 is modified to update the grammatical error in the node 520 and add a new node 540. In such cases, the custom tags can enable these changes to be made after the document has been generated. For example, a reviewer can identify the error in the claims and may suggest adding a new recitation illustrated in node 540. The user can execute the patent-specific application 500 again with the rendered document to promulgate the changes. For example, the user may edit the claims in a separate user interface and the patent-specific application 500 can detect the change to the node 520, and then search the document for custom tags that link that particular claim language to descriptions in the specification, and then update the specification. As illustrated in FIG. 5B, the user may correct the grammatical error in node 520 which then can automatically promulgate the language into the sentence portion 530.

Although FIGS. 5A and 5B illustrate linking of the portions of a sentence based on claim language, other aspects such as reference labels (e.g., block X05), nouns (e.g., the processor 100) can be linked to the patent-specific application 500 as well. For example, FIG. 5B illustrates that the user has created new language in, for example, a dependent claim and inserted the corresponding phrase into the flowchart user interface. As a result, this change modifies the reference labels and moves the reference labels for subsequent nodes, such as reference label X20 in FIG. 5A becoming reference label X25 in FIG. 5B. Based on the modifications to the flowchart user interface, the patent-specific application 500 can insert a new paragraph 550 into the document region 505 with the correct reference label, and also update the subsequent paragraph to update its reference labels X25.

Although FIGS. 5A and 5B illustrate changes from the patent-specific application 500 flowing into a rendered document, the patent-specific application 500 can identify changes in the document and then promulgate the changes into the application, which can then reflow into linked portions of the document. For example, the user may have edited the claim within the document and, when loaded into the patent-specific application 500, the patent-specific application 500 can identify the changes to the claim based on the custom tag attributes having a different value than the child content (e.g., the content within the opening <w:smartTag> tag and the closing </w:smartTag> tag. For example, <w:smartTag phrase=“processor 100”> at least one processor 100</w: SmartTag> identifies that the child content was previously “processor 100” and was changed to “at least one processor 100” after rendering of the document. This links the document state to the application state of the patent-specific application 500.

The patent-specific application 500 can be configured to present information to the user to indicate inconsistencies created by the edits. In some aspects, the patent-specific application 500 can highlight a document region to indicate to the user that the content was changed and is inconsistent with the claim, thereby allowing a user to visually see the issue and address this problem.

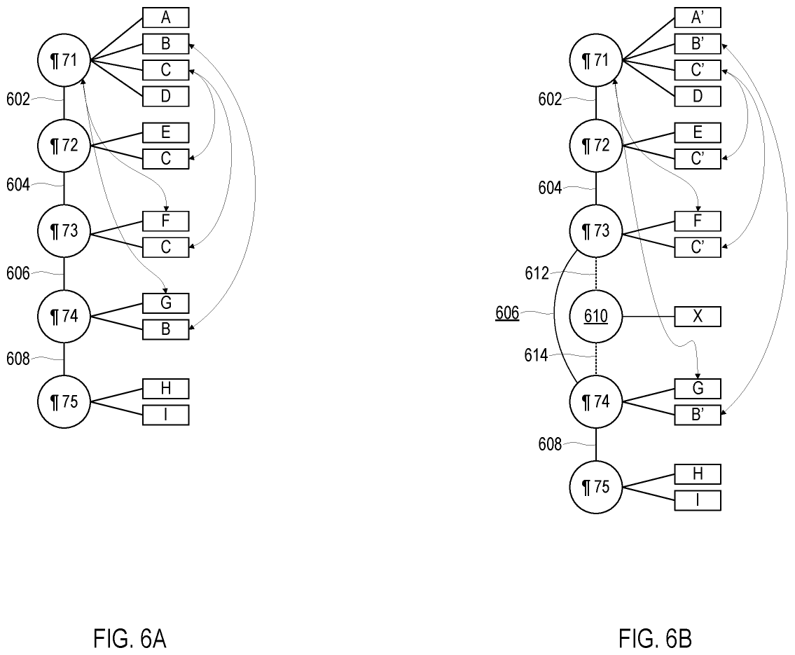

FIGS. 6A and 6B visually illustrate graph objects that can be created by a patent-specific application to identify changes to the document state to update the application state of the patent-specific application in accordance with some examples.

FIG. 6A visually illustrates a portion of initial application state that is stored within the document, in particular paragraphs 71-75. As noted above, the paragraphs can be annotated with data such as paragraph identifiers, with references to previous paragraphs, next paragraphs, corresponding figures, claims, etc. For example, paragraphs 71 and 72 are linked via edge 602, which can be identified using the attributes of the custom tag, paragraphs 72 and 73 are linked via edge 604, paragraphs 73 and 74 are linked via edge 606, and paragraphs 74 and 75 are linked via edge 608. The paragraphs can also include content linked to other objects such as claims, drawings, and so forth. For example, paragraph 71 is linked to claim recitations A, B, C, and D, which can be from a single claim or multiple claims. Paragraph 72 is linked to claim recitations E and C, paragraph 73 is linked to claim recitations F and C, paragraph 74 is linked to claim recitations G and B, and paragraph 75 is linked to claim recitations H and I.

The claim recitations can also be linked to another paragraph, such as claim recitation F and claim recitation G both being linked to paragraph 71. The paragraphs can also be implicitly linked by virtue of being linked to the same claim recitation (e.g., claim recitation B and C in paragraphs 71, 73, and 74.

FIG. 6B visually illustrates a portion of the document state that the patent-specific application can identify and then promulgate into the application state in accordance with some examples. In the illustrative example of FIG. 6B, a new paragraph 610 is inserted between paragraphs 73 and 74 and an implicit edge 612 can be identified between paragraph 73 and new paragraph 610 based on an order of the paragraphs in the document. An implicit edge 614 can be detected between new paragraph 610 and paragraph 74. Using the graph, the patent-specific application 500 can determine that a new paragraph has been inserted. In other cases, edges can be removed which indicate paragraphs removed, etc.

The patent-specific application 500 can alert the user to the existence of the new paragraph 610, or alert the user to the existence that a paragraph has been removed. In some cases, custom XML parts can be used to identify the removed content to allow a user to perform suitable functions, such as approve the deletion, view specific edits to the document, or identify changes to language linked to the claims. The patent-specific application 500 may also be able to detect changes in order of the paragraphs because the order of the paragraphs does not correspond to graph.

FIG. 7 illustrates another patent-specific application 700 configured to convert claim content into specification content in accordance with some examples. The patent-specific application includes an outline user interface 702 and a claim panel 705. The claim panel 705 allows the phrases (or claim segments) of a claim that can be converted into an independent sentence based on the NLP processing to be moved from the claim panel 705 into the outline user interface 702. The outline user interface is configured to display blocks content that has a direct hierarchical relationship and be sequenced in a convenient manner. In some aspects, the outline user interface 702 may be configured to receive content associated with an apparatus claim or a method claim and can generate a complete sentence based on a subject of the phrase. In some cases, a context may also be included and the subject modifies the context.

For example, a node 710 in the outline user interface 702 may be related to a drawing or other content, such as a noun extracted from an apparatus or system claim, that includes a reference label. In FIG. 7, the node 710 is related to a specification drafting module that has a reference numeral of 420. When a user moves phrase 712 from the claim panel 705 into the outline user interface 702 via a drag and drop operation, the patent-specific application 700 can identify a subject of the drag operation and generate a corresponding sentence 722 associated with the phrase 712. As illustrated in FIG. 7, phrases 712, 714, 716, and 718 have been moved into the node 710 to generate sentences 722, 724, 726, and 728.

The outline user interface 702 may also be configured to receive inputs related to formatting the document. For example, a new paragraph indictor 730 can be added into the outline user interface 702 to indicate that a new paragraph begins at this location. This data can be mapped into the custom tags and provide a user the ability to edit a document in an outline format, but provide sufficient formatting ability.

In some aspects, the outline user interface 702 enhances the ability to review and edit a patent application. For example, each node in the outline user interface 702 may be draggable to allow a user to reorganize sentences with simple and understandable user input. In contrast to a document, which can only illustrate a limited structure, the outline user interface 702 allows easier access to manipulate sentences and sections in an intuitive user interface. Table 4 below illustrates an example generated markup for paragraph 173, which includes sentences 722, 724, and 726.

```
TABLE 4
<w:p>
  <w:smartXml>
    <w:smartXmlPr>
      <w:attr w:paragraphId w:val=″173″/>
      <w:attr w:Id w:val=″AJi1a-1mUf1″/>
      <w:attr w:claimId w:val=″1″/>
    </w:smartXmlPr>
  <w:smartXml>
  <w:r>The </w:r>
  <w:smartXml subject=”specification drafting module”
    label=”420”><w:r>specification drafting module 420</w:r></w:smartXml>
  <w:r> may be configured to </w:r>
  <w:smartXml phraseId=”XXXXX” claimId=”1” phrase=”display a user interface
  for moving claim segments from an NLP processing engine”>
    <w:r> display a user interface for moving claim segments from an NLP
    processing engine </w:r>
  </w:smartXml>
  <w:r>. In some aspects, </w:r>
  <w:smartXml phraseId=”YYYYY” claimId=”1” phrase=”each claim segment can be
  converted into a complete sentence”>
    <w:r>each claim segment can be converted into a complete sentence</w:r>
  </w:smartXml>
  </w:r>.</w:r>
</w:p>
```

In the example illustrated in FIG. 4, the custom tags can identify paragraph information, link related content (e.g., claim 1), and insert metadata related to the construction of the paragraph content in the word document into the patent-specific application. For example, custom tags related to claim phrases are directly linked to a claim identifier (e.g., a claim number) and identify a specific phrase that is the original source, as well as identify the expected phrase. If a phrase is modified in the document processing application, the patent-specific application will be able to identify that the child content (e.g., the content between the opening tag such as <w:r> and the closing tag </w:r>) has changed.

Further, the custom tags include a subject that identifies to a parent node and inform the patent-specific application 700 regarding a subject of the sentence. In some cases, the patent-specific application may also include a context, which provides a context of that subject. For example, a description of an apparatus for implementing a method is a context. In some cases, a context can be extracted from a preamble of a method claim or an apparatus claim. In other cases, a context can be extracted from the claim, such as for a wherein clause.

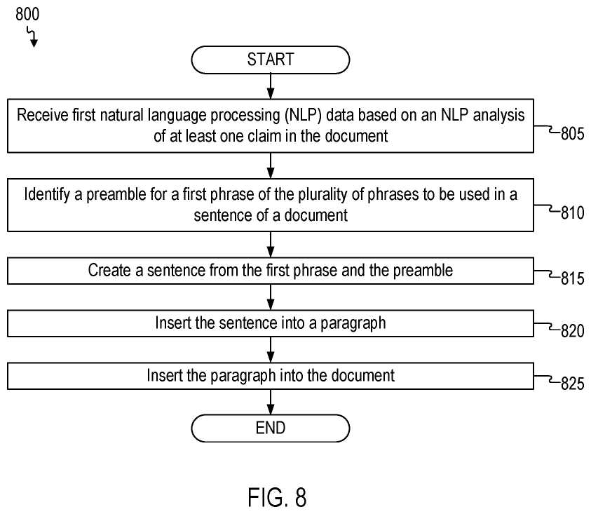

As noted above, the patent-specific application can be independent of the document processing application for editing a document produced by the patent-specific application, or the patent-specific application can be integrated into the document processing application. In the case that the patent-specific application is integrated into the document processing application (e.g., a React-based add-in), the patent-specific application may be configured to access the document and edit the document using the user interface. For example, a Microsoft Word-based add-in application allows the patent-specific application to execute in a side bar and concurrently access and edit the OpenXML. In such cases, the patent-specific application can implement a user interface to allow dynamic editing and writing of a patent application using the disclosed concepts. Various methods of editing a document, either while the document is being edited in a document processing application in conjunction with an example patent-specific application, or the document is being edited independently of the document processing application by an example patent-specific application, is further described below with reference to FIGS. 8-12.

FIG. 8 illustrates an example method 800 for creating a document using a patent-specific application in accordance with some examples. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

According to some examples, the method includes receiving, by a computing system 1300, first NLP data based on an NLP analysis of at least one claim in the document at block 805. The first NLP data including a plurality of phrases that can be converted into individual sentences. As noted above, the phrases can be used in the various disclosed user interfaces to sequence together a description and, the phrases can be tagged in the document so that the document state can be imported into a patent-specific application.

According to some examples, the method includes identifying a preamble for a first phrase of the plurality of phrases at block 810. A preamble can be a subject of the sentence and can be identified based on a preamble of a claim, a context of the claim, or based on user input into the patent-specific application.

According to some examples, the method includes creating a sentence from the first phrase and the preamble at block 815. According to some aspects, the sentence may a custom element that includes the first phrase. For example, the sentence may include a custom tag to map state of the patent-specific application into the document.

According to some examples, the method includes inserting the sentence into a paragraph at block 820. As noted above, the paragraph identifier maps application information (e.g., application state) into the document, and the document state can be extracted based on a difference of the application state and document content. For example, the custom element includes a property to determine that text of the first phrase was edited in the document processing application. In some cases, a custom element including a paragraph identifier can be embedded in the paragraph. The paragraph is generated based on an instance of a flowchart user interface for visually arranging the first NLP data.

According to some examples, the method includes inserting the paragraph into the document at block 825. The first phrase in the custom element (e.g., the custom tag) may be immutable in a document processing application, and the first phrase in the sentence is mutable in the document processing application. For example, an attribute of the custom tag cannot be mutated in the document, but the child content of the custom tag can be changed within the document processing application. In some cases, the document may include a custom XML part that includes at least a portion of the first NLP data.

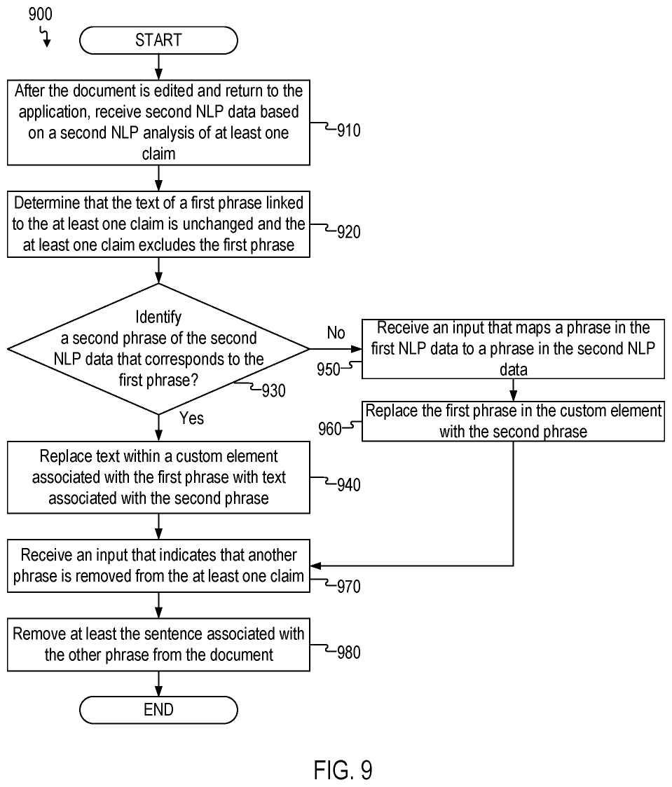

FIG. 9 illustrates a method 900 for updating a document that was created by an automation application and revised in a document processing application in accordance with some examples. Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

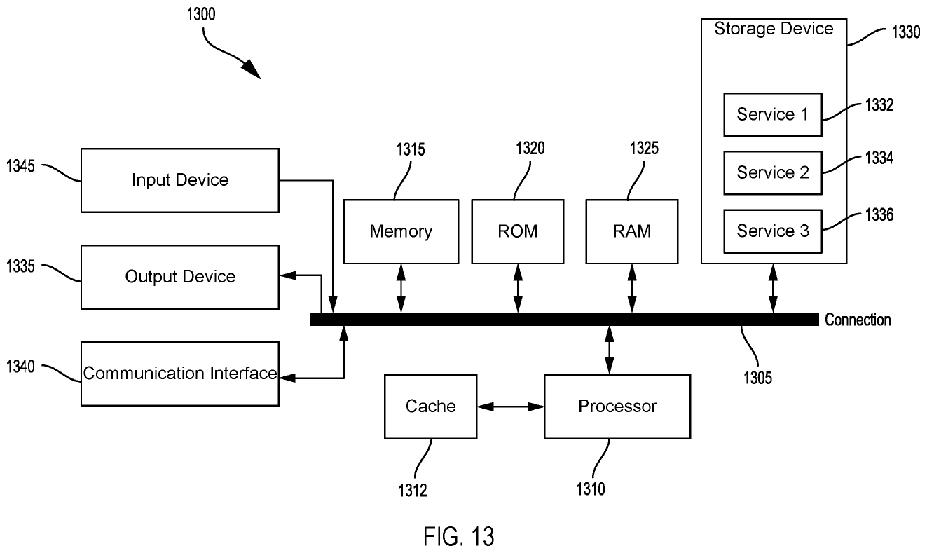

According to some examples, the method 900 may be executed, for example, by a computing system 1300 illustrated in FIG. 13. Initially, the method begins by, after the document is edited in a document processing application and returned to the application, receiving second NLP data based on a second NLP analysis of at least one claim at block 910. At block 920, the method 900 determines that the text of a first phrase linked to the at least one claim is unchanged and the at least one claim excludes the first phrase. In some cases, block 920 corresponds to a change in the claim based on an external edit, such as by an inventor or an in-house counsel.

At block 930, the method 900 may be configured to identify a second phrase of the second NLP data that corresponds to the first phrase. In some cases, a similarity can be used at the NLP server, or a Levenstein distance can be computed, which identifies a number of changes that would be required for the text to have value equality.

If the second phrase is identified at block 930, the method 900 proceeds to block 940 and replaces text within a custom element associated with the first phrase with text associated with the second phrase. For example, the method 900 can identify text corresponding to the first phrase in other claims (e.g., an apparatus claim) or in different parts of the specification (e.g., the description, the abstract, etc.) and replace that text.

If the second phrase is identified at block 940, the method 900 can receive an input that maps a phrase in the first NLP data to a phrase in the second NLP data at block 950. For example, the application may display a node associated with a flowchart to indicate that the node cannot be identified and is not included in the claims, and the user may input a replacement phrase to indicate that the phrase is replaced with the replacement phrase. At block 960, the method 900 may be configured to replace the first phrase in the custom element with the second phrase at block 960.

After block 940 or 960, the method 900 continues to block 970 and receives an input that indicates that another phrase is removed from the at least one claim. In light of the indication that the other phrase is removed, the method 900 can remove at least the sentence associated with the other phrase from the document at block 980.

In some aspects, FIG. 9 illustrates an example of how the custom tags can be used to update a document based on a change in the claims of a patent application. In particular, a change based on an automated identification (e.g., based on similarity or other identification), a change based on user input to modify a phrase from the original application state, and a change to remove a sentence based on that portion of the claim being repudiated during review.

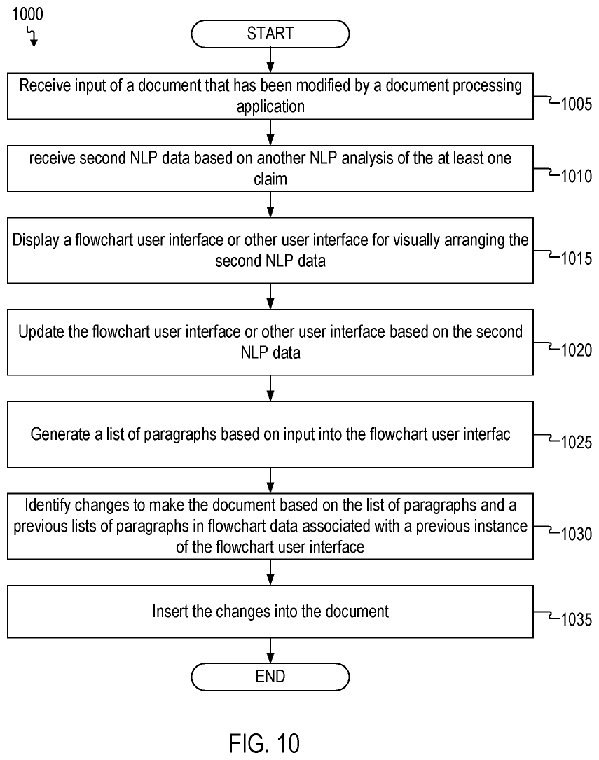

FIG. 10 illustrates an example method 1000 of using custom tags and a user interface based on modification to a document in accordance with some examples. Initially, the method 1000 comprises receiving a document that was previously generated using an automation application (e.g., a patent-specific application) and modified by a document processing application at block 1005. In some aspects, the automation application may process the document and receive NLP data associated. For example, at block 1010, the automation application may receive second NLP data based on another NLP analysis of the at least one claim.

The automation application may display a flowchart user interface or another user interface for visually arranging the second NLP data at block 1015. In some aspects, the automation application can display an outline interface for hierarchically organizing content. The flowchart user interface or another user interface can include a restored state of a flowchart or other interface based on flowchart data. In some cases, the flowchart data can be stored in the document (e.g., a custom XML part) or can be retrieved from a server, and the data can include the plurality of phrases associated with the first NLP data (e.g., the previous instance of the automation application).

At block 1020, the method can include updating the flowchart user interface or other user interface based on the second NLP data. For example, the updating the user interface can include identifying a second phrase in the second NLP data that is similar to the first phrase, identifying a node in the flowchart corresponding to the first phrase, and updating the node to correspond to the second phrase. In this manner, the automation application can identify changes made to the application and promulgate those changes into the automation application.

In other examples, a node in the flowchart corresponding to the first phrase is displayed to indicate that the first phrase is not included in the second NLP data when a phrase is determined to not correspond to the first phrase. This can provide an indication to the user of a difference and allow the user to take corrective action.

The method includes generating a list of paragraphs based on input into the flowchart user interface at block 1025. After generating the list of paragraphs, the method can identify changes to make the document based on the list of paragraphs and a previous list of paragraphs in flowchart data associated with a previous instance of the flowchart user interface at block 1130. For example, the changes to make to the document are identified based on custom elements associated with the plurality of phrases or paragraph identifiers that identify a sequential list of paragraphs After identifying the changes, the method can insert the changes into the document to maintain changes that occur in the automation application to be consistent with the contents of the document at block 1035.

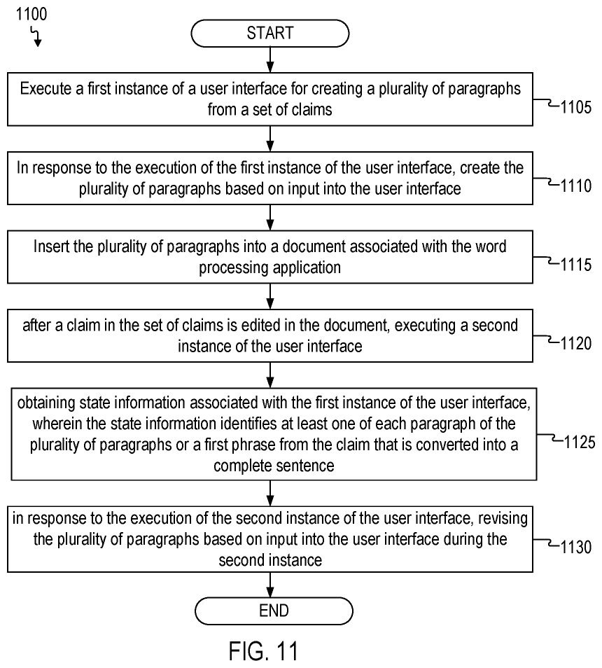

FIG. 11 illustrates a method 1100 for updating an application state based on custom tags embedded in the document in accordance with some examples. According to some examples, the method 1100 may be executed, for example, by a computing system 1300 illustrated in FIG. 13.

At block 1105, the method includes executing a first instance of a user interface for creating a plurality of paragraphs from a set of claims. The set of claims may be analyzed using an NLP server in conjunction with the user interface to generate a plurality of phrases.

At block 1110, the method includes, in response to the execution of the first instance of the user interface, creating the plurality of paragraphs based on input into the user interface. Each paragraph may include an identifier property to identify map state information between different instances of the user interface. In some cases, the state information may be stored within a custom XML part of the document and store various information. For example, the custom XML can identify an iteration identifier of the user interface and then indicate to the user that the document is stale, and a newer version of the document was created that may or may not be different.

At block 1115, the method includes inserting the plurality of paragraphs into a document associated with the document processing application

At block 1120, the method includes, after a claim in the set of claims is edited in the document, executing a second instance of the user interface.

At block 1125, the method includes obtaining state information associated with the first instance of the user interface. For example, the state information identifies at least one of each paragraph of the plurality of paragraphs or a first phrase from the claim that is converted into a complete sentence. In some aspects, each phrase from the set of claims that is inserted into the document includes a custom extensible markup language (XML) element such as a custom tag. The custom tag may include a run element (<w:r>), and wherein the run element comprises a text element (<w:t>). In comparison to the above-described examples, the text element was omitted for simplicity. In some aspects, the custom tag may also be implemented using a structured document to apply identifiers and content to the inline content. For example, a structured document tag (e.g., <w:std>, which may also be referred to as a content control, may add semantic information while providing a customizable presentation for the content within that structured document tag. For example, structured document tags can be used to visually identify a format a date, identify content of that tag, etc. In some cases, the structured document tags can be combined with the smart tags to further converge application state and document state.

At block 1130, the method includes in response to the execution of the second instance of the user interface, revising the plurality of paragraphs based on input into the user interface during the second instance. The revising of the plurality of paragraphs can include comparing the state information associated with the first instance of the user interface with state information associated with the second instance of the user interface, and identifying the first phrase in a first paragraph of the plurality of paragraphs. Different types of revisions can be performed and are related to the type of change. For example, the method may replace the first phrase with a second phrase, which can occur when the second phrase is edited in the claim based on the first phrase. In another example, the method may remove the first paragraph from the plurality of paragraphs, which occurs when the first phrase is edited and removed from the claim. In another example, the method may insert a second paragraph into the plurality of paragraphs based on a second phrase, which can occur when the claim is edited to include the second phrase.

In some aspects, the revising the plurality of paragraphs can include replacing a reference label in the plurality of paragraphs based on the input into the user interface during the second instance. For example, a user may modify a content using a flowchart user interface, or some other graphical user interface to construct the document. The reference labels in the plurality of paragraphs can be updated based on the modifications.

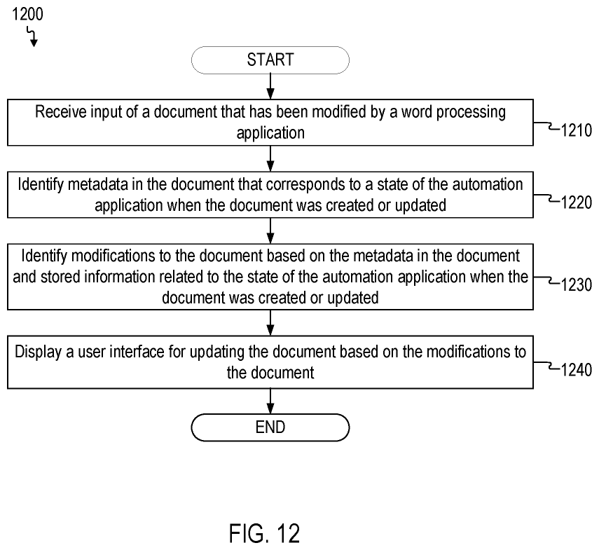

FIG. 12 illustrates another method 1200 for updating a document that was created by an automation application and revised in a document processing application in accordance with some examples. According to some examples, the method includes receiving input of a document that has been modified by a document processing application at block 1210.

After receiving the document, the method includes identifying metadata in the document that corresponds to a state of the automation application when the document was created or updated at block 1220. The method includes identifying modifications to the document based on the metadata in the document and stored information related to the state of the automation application when the document was created or updated at block 1230.

According to some examples, the method includes displaying a user interface for updating the document based on the modifications to the document at block 1240. In some cases, the user interface comprises an option to promulgate a modification to a claim to portions of the document that are generated from the claim prior to the modification. The user interface comprises a warning identifying an inconsistency between at least one claim and at least one sentence in the specification.

FIG. 13 shows an example of computing system 1300, which can be for example any computing device making up any network node such as the client 302, webserver 304, or NLP server 306, or any component thereof in which the components of the system are in communication with each other using connection 1305. Connection 1305 can be a physical connection via a bus, or a direct connection into processor 1310, such as in a chipset architecture. Connection 1305 can also be a virtual connection, networked connection, or logical connection.

In some embodiments computing system 1300 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example computing system 1300 includes at least one processing unit (CPU or processor) 1310 and connection 1305 that couples various system components including system memory 1315, such as ROM 1320 and RAM 1325 to processor 1310. Computing system 1300 can include a cache of high-speed memory 1312 connected directly with, in close proximity to, or integrated as part of processor 1310.

Processor 1310 can include any general-purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which can represent any number of input mechanisms, such as a microphone for speech, a touch-sensitive screen for gesture or graphical input, keyboard, mouse, motion input, speech, etc. Computing system 1300 can also include output device 1335, which can be one or more of a number of output mechanisms known to those of skill in the art. In some instances, multimodal systems can enable a user to provide multiple types of input/output to communicate with computing system 1300. Computing system 1300 can include communications interface 1340, which can generally govern and manage the user input and system output. There is no restriction on operating on any particular hardware arrangement and therefore the basic features here may easily be substituted for improved hardware or firmware arrangements as they are developed.

Storage device 1330 can be a non-volatile memory device and can be a hard disk or other types of computer readable media which can store data that are accessible by a computer, such as magnetic cassettes, flash memory cards, solid state memory devices, digital versatile disks, cartridges, RAMs, ROMs, and/or some combination of these devices.

The storage device 1330 can include software services, servers, services, etc., that, when the code that defines such software is executed by the processor 1310, causes the system to perform a function. In some embodiments, a hardware service that performs a particular function can include the software component stored in a computer-readable medium in connection with the necessary hardware components, such as processor 1310, connection 1305, output device 1335, etc., to carry out the function.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

In some examples, the system can be implemented in a virtualized and/or container system. For example, the system can be implemented in a single or multiple Docker containers on a Docker Host. As an example, various aspects of the system can be separated into different containers to isolate functions (e.g., application, storage, etc.) across a single Docker host or multiple Docker hosts. In another example, the system can be implemented in a scalable container system (e.g., a Kubernetes cluster) that automatically provisions containers, networking, load balancing, security, and scaling of the system.

Illustrative examples of the disclosure include:
Aspect 1. A method of first application that executes in conjunction with a word processing application, comprising: receiving first natural language processing (NLP) data based on an NLP analysis of at least one claim in the document, the first NLP data including a plurality of phrases that can be converted into individual sentences; identifying a preamble for a first phrase of the plurality of phrases; creating a sentence from the first phrase and the preamble, the sentence including a custom element that includes the first phrase; inserting the sentence into a paragraph; and inserting the paragraph into the document, wherein the first phrase in the custom element is immutable in a document processing application, and wherein the first phrase in the sentence is mutable in the document processing application.
Aspect 2. The method of Aspect 1, wherein a custom element including a paragraph identifier is embedded in the paragraph, wherein the paragraph identifier maps application information into the document.
Aspect 3. The method of any of Aspects 1 to 2, wherein the document includes a custom XML part that includes at least a portion of the first NLP data.
Aspect 4. The method of any of Aspects 1 to 3, wherein the custom element includes a property to determine that text of the first phrase was edited in the word processing application.
Aspect 5. The method of any of Aspects 1 to 4, further comprising receiving second NLP data based on a second NLP analysis of at least one claim, wherein the at least one claim is modified based on input into the word processor application.
Aspect 6. The method of any of Aspects 1 to 5, wherein a format is applied to the first phrase to visually change the appearance of the first phrase to indicate that the text of the first phrase was modified and cannot be updated by the first application.
Aspect 7. The method of any of Aspects 1 to 6, further comprising: determining that the text of the first phrase is unchanged and the at least one claim excludes the first phrase.
Aspect 8. The method of any of Aspects 1 to 7, further comprising: determining that text associated with a phrase in the first NLP data corresponds to a phrase in the second NLP data that was not included in the first NLP data; and replacing the phrase in the first NLP data in the custom element with the phrase in the second NLP data.
Aspect 9. The method of any of Aspects 1 to 8, further comprising: receiving an input that maps a phrase in the first NLP data to a phrase in the second NLP data; and in response to the input, replacing the first phrase in the custom element with the second phrase.
Aspect 10. The method of any of Aspects 1 to 9, further comprising: receiving an input that indicates that the first phrase is removed from the at least one claim; and removing at least the sentence from the document.
Aspect 11. The method of any of Aspects 1 to 10, wherein the paragraph is generated based on an instance of a flowchart user interface for visually arranging the first NLP data, and wherein the method further comprises: receiving second NLP data based on another NLP analysis of the at least one claim; and displaying a flowchart user interface for visually arranging the second NLP data.
Aspect 12. The method of any of Aspects 1 to 11, further comprising restoring a state of a flowchart based on flowchart data.
Aspect 13. The method of any of Aspects 1 to 12, wherein the flowchart data including the plurality of phrases associated with the first NLP data is stored in the document.
Aspect 14. The method of any of Aspects 1 to 13, wherein the flowchart data including the first plurality of phrases associated with the first NLP data is retrieved from a server.
Aspect 15. The method of any of Aspects 1 to 14, wherein restoring the state of the flowchart comprises determining that the second NLP data does not include the first phrase.
Aspect 16. The method of any of Aspects 1 to 15, further comprising: identifying a second phrase in the second NLP data that is similar to the first phrase; identifying a node in the flowchart corresponding to the first phrase; and updating the node to correspond to the second phrase.
Aspect 17. The method of any of Aspects 1 to 16, wherein a node in the flowchart corresponding to the first phrase is displayed to indicate that the first phrase is not included in the second NLP data when a phrase is determined to not correspond to the first phrase.
Aspect 18. The method of any of Aspects 1 to 17, further comprising: generating a list of paragraphs based on input into the flowchart user interface; identifying changes to make the document based on the list of paragraphs and a previous list of paragraphs in flowchart data associated with a previous instance of the flowchart user interface.
Aspect 19. The method of any of Aspects 1 to 18, wherein the changes to make to the document are identified based on custom elements associated with the plurality of phrases or paragraph identifiers that identify a sequential list of paragraphs.
Aspect 20. The method of any of Aspects 1 to 19, wherein inserting the paragraph comprises: reading a first extensible markup language (XML) content from a body of the document in a first context sync with the word processing application; inserting the paragraph into a designated portion of the first XML content; inserting or modifying custom XML part of the document; and writing the first XML into the body of the document in a second context sync.
Aspect 21. A method of first application that executes in conjunction with a word processing application, comprising: executing a first instance of a user interface for creating a plurality of paragraphs from a set of claims; in response to the execution of the first instance of the user interface, creating the plurality of paragraphs based on input into the user interface; inserting the plurality of paragraphs into a document associated with the word processing application; after a claim in the set of claims is edited in the document, executing a second instance of the user interface; and in response to the execution of the second instance of the user interface, revising the plurality of paragraphs based on input into the user interface during the second instance.
Aspect 22. The method of Aspect 21, further comprising: obtaining state information associated with the first instance of the user interface, wherein the state information identifies at least one of each paragraph of the plurality of paragraphs or a first phrase from the claim that is converted into a complete sentence.
Aspect 23. The method of any of Aspects 21 to 22, wherein revising the plurality of paragraphs comprises: comparing the state information associated with the first instance of the user interface with state information associated with the second instance of the user interface; and identifying the first phrase in a first paragraph of the plurality of paragraphs.
Aspect 24. The method of any of Aspects 21 to 23, further comprising: replacing the first phrase with a second phrase, wherein the second phrase is edited in the claim based on the first phrase.
Aspect 25. The method of any of Aspects 21 to 24, further comprising: removing the first paragraph from the plurality of paragraphs, wherein the first phrase is edited and removed from the claim.
Aspect 26. The method of any of Aspects 21 to 25, further comprising: inserting a second paragraph into the plurality of paragraphs based on a second phrase, wherein the claim is edited to include the second phrase.
Aspect 27. The method of any of Aspects 21 to 26, wherein each phrase from the set of claims comprises a custom extensible markup language (XML) element that includes a run element, and wherein the run element comprises a text element.
Aspect 28. The method of any of Aspects 21 to 27, wherein each paragraph includes an identifier property to identify map state information between different instances of the user interface.
Aspect 29. The method of any of Aspects 21 to 28, wherein the set of claims is analyzed using a natural language processor (NLP) server in conjunction with the user interface to generate a plurality of phrases.
Aspect 30. The method of any of Aspects 21 to 29, wherein the state information is stored within a custom XML part of the document.
Aspect 31. The method of any of Aspects 21 to 30, wherein revising the plurality of paragraphs based on input into the user interface during the second instance comprises: replacing a reference label in the plurality of paragraphs based on the input into the user interface during the second instance.
Aspect 32. A method for creating and editing a document by an automation application for creating and editing specific documents, comprising: receiving input of a document that has been modified by a word processing application; identifying metadata in the document that corresponds to a state of the automation application when the document was created or updated; and identifying modifications to the document based on the metadata in the document and stored information related to the state of the automation application when the document was created or updated; displaying a user interface for updating the document based on the modifications to the document.
Aspect 33. The method of Aspect 32, further comprising: identifying a custom element in a paragraph of the document that identifies a state of the document before the modifications by the word processing application; and determining if content created by the automation application was modified based on child content of the custom element and an attribute of the custom element.
Aspect 34. The method of any of Aspects 32 to 33, wherein the user interface comprises a warning identifying an inconsistency between at least one claim and at least one sentence in the specification.
Aspect 35. The method of any of Aspects 32 to 34, wherein the user interface comprises an option to promulgate a modification to a claim to portions of the document that are generated from the claim prior to the modification.
Aspect 36: A system includes a storage (implemented in circuitry) configured to store instructions and a processor. The processor configured to execute the instructions and cause the processor to: receive first natural language processing (NLP) data based on an NLP analysis of at least one claim in the document, the first NLP data including a plurality of phrases that can be converted into individual sentences; identify a preamble for a first phrase of the plurality of phrases; create a sentence from the first phrase and the preamble, the sentence including a custom element that includes the first phrase; insert the sentence into a paragraph; and insert the paragraph into the document, wherein the first phrase in the custom element is immutable in a document processing application, and wherein the first phrase in the sentence is mutable in the document processing application.
Aspect 37: The system of Aspect 36, wherein a custom element including a paragraph identifier is embedded in the paragraph, wherein the paragraph identifier maps application information into the document.
Aspect 38: The system of any of Aspects 36 to 37, wherein the document includes a custom XML part that includes at least a portion of the first NLP data.
Aspect 39: The system of any of Aspects 36 to 38, wherein the custom element includes a property to determine that text of the first phrase was edited in the word processing application.
Aspect 40: The system of any of Aspects 36 to 39, wherein the processor is configured to execute the instructions and cause the processor to: receive second NLP data based on a second NLP analysis of at least one claim, wherein the at least one claim is modified based on input into the word processor application.
Aspect 41: The system of any of Aspects 36 to 40, wherein a format is applied to the first phrase to visually change the appearance of the first phrase to indicate that the text of the first phrase was modified and can not be updated by the first application.
Aspect 42: The system of any of Aspects 36 to 41, wherein the processor is configured to execute the instructions and cause the processor to: determine that the text of the first phrase is unchanged and the at least one claim excludes the first phrase.
Aspect 43: The system of any of Aspects 36 to 42, wherein the processor is configured to execute the instructions and cause the processor to: determine that text associated with a phrase in the first NLP data corresponds to a phrase in the second NLP data that was not included in the first NLP data; and replace the phrase in the first NLP data in the custom element with the phrase in the second NLP data.
Aspect 44: The system of any of Aspects 36 to 43, wherein the processor is configured to execute the instructions and cause the processor to: receive an input that maps a phrase in the first NLP data to a phrase in the second NLP data; and in response to the input, replace the first phrase in the custom element with the second phrase.
Aspect 45: The system of any of Aspects 36 to 44, wherein the processor is configured to execute the instructions and cause the processor to: receive an input that indicates that the first phrase is removed from the at least one claim; and remove at least the sentence from the document.
Aspect 46: The system of any of Aspects 36 to 45, wherein the paragraph is generated based on an instance of a flowchart user interface for visually arranging the first NLP data, and wherein the method further comprises: receive second NLP data based on another NLP analysis of the at least one claim; and display a flowchart user interface for visually arranging the second NLP data.
Aspect 47: The system of any of Aspects 36 to 46, wherein the processor is configured to execute the instructions and cause the processor to: restore a state of a flowchart based on flowchart data.
Aspect 48: The system of any of Aspects 36 to 47, wherein the flowchart data including the plurality of phrases associated with the first NLP data is stored in the document.
Aspect 49: The system of any of Aspects 36 to 48, wherein the flowchart data including the first plurality of phrases associated with the first NLP data is retrieved from a server.
Aspect 50: The system of any of Aspects 36 to 49, wherein restoring the state of the flowchart comprises determining that the second NLP data does not include the first phrase.
Aspect 51: The system of any of Aspects 36 to 50, wherein the processor is configured to execute the instructions and cause the processor to: identify a second phrase in the second NLP data that is similar to the first phrase; identify a node in the flowchart corresponding to the first phrase; and update the node to correspond to the second phrase.
Aspect 52: The system of any of Aspects 36 to 51, wherein a node in the flowchart corresponding to the first phrase is displayed to indicate that the first phrase is not included in the second NLP data when a phrase is determined to not correspond to the first phrase.
Aspect 53: The system of any of Aspects 36 to 52, wherein the processor is configured to execute the instructions and cause the processor to: generate a list of paragraphs based on input into the flowchart user interface; identify changes to make the document based on the list of paragraphs and a previous list of paragraphs in flowchart data associated with a previous instance of the flowchart user interface.
Aspect 54: The system of any of Aspects 36 to 53, wherein the changes to make to the document are identified based on custom elements associated with the plurality of phrases or paragraph identifiers that identify a sequential list of paragraphs.
Aspect 55: The system of any of Aspects 36 to 54, wherein the processor is configured to execute the instructions and cause the processor to: read a first extensible markup language (XML) content from a body of the document in a first context sync with the word processing application; insert the paragraph into a designated portion of the first XML content; insert or modifying custom XML part of the document; and write the first XML into the body of the document in a second context sync.
Aspect 56: A system includes a storage (implemented in circuitry) configured to store instructions and a processor. The processor configured to execute the instructions and cause the processor to: execute a first instance of a user interface for creating a plurality of paragraphs from a set of claims; in response to the execution of the first instance of the user interface, create the plurality of paragraphs based on input into the user interface; insert the plurality of paragraphs into a document associated with the word processing application; after a claim in the set of claims is edited in the document, execute a second instance of the user interface; and in response to the execution of the second instance of the user interface, revise the plurality of paragraphs based on input into the user interface during the second instance.
Aspect 57: The system of Aspect 56, wherein the processor is configured to execute the instructions and cause the processor to: obtain state information associated with the first instance of the user interface, wherein the state information identifies at least one of each paragraph of the plurality of paragraphs or a first phrase from the claim that is converted into a complete sentence.
Aspect 58: The system of any of Aspects 56 to 57, wherein the processor is configured to execute the instructions and cause the processor to: compare the state information associated with the first instance of the user interface with state information associated with the second instance of the user interface; and identify the first phrase in a first paragraph of the plurality of paragraphs.
Aspect 59: The system of any of Aspects 56 to 58, wherein the processor is configured to execute the instructions and cause the processor to: replace the first phrase with a second phrase, wherein the second phrase is edited in the claim based on the first phrase.
Aspect 60: The system of any of Aspects 56 to 59, wherein the processor is configured to execute the instructions and cause the processor to: remove the first paragraph from the plurality of paragraphs, wherein the first phrase is edited and removed from the claim.
Aspect 61: The system of any of Aspects 56 to 60, wherein the processor is configured to execute the instructions and cause the processor to: insert a second paragraph into the plurality of paragraphs based on a second phrase, wherein the claim is edited to include the second phrase.
Aspect 62: The system of any of Aspects 56 to 61, wherein each phrase from the set of claims comprises a custom extensible markup language (XML) element that includes a run element, and wherein the run element comprises a text element.
Aspect 63: The system of any of Aspects 56 to 62, wherein each paragraph includes an identifier property to identify map state information between different instances of the user interface.
Aspect 64: The system of any of Aspects 56 to 63, wherein the set of claims is analyzed using a natural language processor (NLP) server in conjunction with the user interface to generate a plurality of phrases.
Aspect 65: The system of any of Aspects 56 to 64, wherein the state information is stored within a custom XML part of the document.
Aspect 66: The system of any of Aspects 56 to 65, wherein the processor is configured to execute the instructions and cause the processor to: replace a reference label in the plurality of paragraphs based on the input into the user interface during the second instance.
Aspect 67: A system includes a storage (implemented in circuitry) configured to store instructions and a processor. The processor configured to execute the instructions and cause the processor to: receive input of a document that has been modified by a word processing application; identify metadata in the document that corresponds to a state of the automation application when the document was created or updated; and identify modifications to the document based on the metadata in the document and stored information related to the state of the automation application when the document was created or updated; display a user interface for updating the document based on the modifications to the document.
Aspect 68: The system of Aspect 67, wherein the processor is configured to execute the instructions and cause the processor to: identify a custom element in a paragraph of the document that identifies a state of the document before the modifications by the word processing application; and determining if content created by the automation application was modified based on child content of the custom element and an attribute of the custom element.
Aspect 69: The system of any of Aspects 67 to 68, wherein the user interface comprises a warning identifying an inconsistency between at least one claim and at least one sentence in the specification.
Aspect 70: The system of any of Aspects 67 to 69, wherein the user interface comprises an option to promulgate a modification to a claim to portions of the document that are generated from the claim prior to the modification.

1. A method of first application that executes in conjunction with a document processing application, comprising:
receiving first natural language processing (NLP) data based on an NLP analysis of at least one claim in a document, the first NLP data including a plurality of phrases that can be converted into individual sentences;
identifying a preamble for a first phrase of the plurality of phrases;
creating a sentence from the first phrase and the preamble, the sentence including a custom element that includes the first phrase;
inserting the sentence into a paragraph; and
inserting the paragraph into the document, wherein the first phrase in the custom element is immutable in a document processing application, and wherein the first phrase in the sentence is mutable in the document processing application.

2. The method of claim 1, wherein a custom element including a paragraph identifier is embedded in the paragraph, wherein the paragraph identifier maps application information into the document.

3. The method of claim 1, wherein the document includes a custom XML part that includes at least a portion of the first NLP data.

4. The method of claim 1, wherein the custom element includes a property to determine that text of the first phrase was edited in the document processing application.

5. The method of claim 4, further comprising receiving second NLP data based on a second NLP analysis of at least one claim, wherein the at least one claim is modified based on input into the word processor application.

6. The method of claim 5, wherein a format is applied to the first phrase to visually change the appearance of the first phrase to indicate that the text of the first phrase was modified and cannot be updated by the first application.

7. The method of claim 5, further comprising:
determining that the text of the first phrase is unchanged and the at least one claim excludes the first phrase.

8. The method of claim 7, further comprising:
determining that text associated with a phrase in the first NLP data corresponds to a phrase in the second NLP data that was not included in the first NLP data; and
replacing the phrase in the first NLP data in the custom element with the phrase in the second NLP data.

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A method of first application that executes in conjunction with a document processing application, comprising:
executing a first instance of a user interface for creating a plurality of paragraphs from a set of claims;
in response to the execution of the first instance of the user interface, creating the plurality of paragraphs based on input into the user interface;
inserting the plurality of paragraphs into a document associated with the document processing application;
after a claim in the set of claims is edited in the document, executing a second instance of the user interface; and
in response to the execution of the second instance of the user interface, revising the plurality of paragraphs based on input into the user interface during the second instance.

22. The method of claim 21, further comprising:
obtaining state information associated with the first instance of the user interface, wherein the state information identifies at least one of each paragraph of the plurality of paragraphs or a first phrase from the claim that is converted into a complete sentence.

23. The method of claim 22, wherein revising the plurality of paragraphs comprises:
comparing the state information associated with the first instance of the user interface with state information associated with the second instance of the user interface; and
identifying the first phrase in a first paragraph of the plurality of paragraphs.

24. The method of claim 23, further comprising:
replacing the first phrase with a second phrase, wherein the second phrase is edited in the claim based on the first phrase.

25. The method of claim 23, further comprising:
removing the first paragraph from the plurality of paragraphs, wherein the first phrase is edited and removed from the claim.

26. The method of claim 23, further comprising:
inserting a second paragraph into the plurality of paragraphs based on a second phrase, wherein the claim is edited to include the second phrase.

27. The method of claim 23, wherein each phrase from the set of claims comprises a custom extensible markup language (XML) element that includes a run element, and wherein the run element comprises a text element.

28. The method of claim 23, wherein each paragraph includes an identifier property to identify map state information between different instances of the user interface.

29. (canceled)

30. (canceled)

31. (canceled)

32. A method for creating and editing a document by an automation application for creating and editing specific documents, comprising:
receiving input of a document that has been modified by a document processing application;
identifying metadata in the document that corresponds to a state of the automation application when the document was created or updated;
identifying modifications to the document based on the metadata in the document and stored information related to the state of the automation application when the document was created or updated; and
displaying a user interface for updating the document based on the modifications to the document.

33. The method of claim 32, further comprising:
identifying a custom element in a paragraph of the document that identifies a state of the document before the modifications by the document processing application; and
determining if content created by the automation application was modified based on child content of the custom element and an attribute of the custom element.

34. The method of claim 32, wherein the user interface comprises an option to promulgate a modification to a claim to portions of the document that are generated from the claim prior to the modification.

35. The method of claim 33, wherein the user interface comprises a warning identifying an inconsistency between at least one claim and at least one sentence in the specification.
